(19) United States
(12) Patent Application Publication
(10) Pub. No.: US 2010/0096419 A1
(43) Pub. Date: Apr. 22, 2010

(54) CHILD CARRIERS AND METHODS FOR PROTECTING A YOUNG CHILD

(76) Inventor: Matthew Stephens, Cincinnati, OH (US)

Correspondence Address: ULMER & BERNE, LLP;ATTN: DIANE BELL, 600 VINE STREET, SUITE 2800, CINCINNATI, OH, 45202-2409, US

(21) Appl. No.: 12/252,928

(22) Filed: Oct. 16, 2008

(51) Int. Cl. A47D 13/02; B64D 17/30

(52) U.S. Cl. 224/153; 224/159; 224/160; 224/584; 224/577; 244/151 R

(57) ABSTRACT

A child carrier includes a flexible shell having a main section and at least one flap section extending from the main section. The flap section(s) is/are selectively foldable with respect to the main section from an opened position to a wrapped position. When the flap section(s) is/are in a wrapped position, the main section and flap section(s) cooperate to define a cavity and to restrain a child's torso, arms, and legs within the cavity. Methods for protecting a young child are also provided.

### TECHNICAL FIELD

Child carriers are provided, as are methods for protecting a young child.

### BACKGROUND

Child carriers are conventionally employed to enable the carrying of a child by an adult. Conventional child carriers are provided in various forms such as slings, backpack carriers, and soil front or hip carriers, with varying materials and degrees of rigidity and decoration, and which provide various levels of support and confinement to a child. Some conventional child carriers allow an adult to carry a child while allowing the arms and legs of the child to remain free.

Conventional flotation devices are designed to keep a wearer afloat and his or her head above water, often in swimming pools, rivers, lakes, and oceans. Conventional flotation devices often appear in the form of a simple vest or a jacket, and are available in various sizes and designs for providing various levels of protection. Many conventional flotation devices include foam or one or more air chambers to effect their buoyancy, as well as that of the supported person.

### SUMMARY

In accordance with one embodiment, a child carrier comprises a flexible shell, a fastener, and a carrier strap. The flexible shell comprises a main section and at least one flap section extending from the main section. The flap section(s) is/are selectively foldable with respect to the main section from an opened position to a wrapped position. In the wrapped position, the flap section(s) is/are configured to cooperate with the main section to define a cavity and restrain a child's torso, arms, and legs within the cavity. The fastener is attached to the flexible shell and is configured to selectively retain the flap section(s) in the wrapped position. The carrier strap is attached to the flexible shell.

In accordance with another embodiment, a child carrier comprises a flexible shell. The flexible shell comprises a main section and at least one flap section extending from the main section. The flap section(s) is/are selectively foldable with respect to the main section from an opened position to a wrapped position. In the wrapped position, the flap section(s) is/are configured to cooperate with the main section to define a cavity and restrain a child's torso, arms, and legs within the cavity. At least one of the main section and the flap section(s) defines an inflatable chamber.

In accordance with yet another embodiment, a child carrier comprises a flexible shell, a fastener, and a parachute. The flexible shell comprises a main section and at least one flap section extending from the main section. The flap section(s) is/are selectively foldable with respect to the main section from an opened position to a wrapped position. In the wrapped position, the flap section(s) is/are configured to cooperate with the main section to define a cavity and restrain a child's torso, arms, and legs within the cavity. The fastener is attached to the flexible shell and is configured to selectively retain the flap section(s) in the wrapped position. The parachute is coupled with the flexible shell.

In accordance with yet another embodiment, a method for protecting a young child is provided. The method comprises placing a child on a main section of a flexible shell. A flap section of the flexible shell is folded over a portion of the child. The flap section extends from the main section. The flap section is secured with respect to the main section such that the flap section cooperates with the main section to restrain the child's torso, arms, and legs. The flexible shell is carried through use of a carrier strap attached to the flexible shell.

In accordance with still another embodiment, a method for protecting a young child is provided. The method comprises placing a child on a main section of a flexible shell. A flap section of the flexible shell is folded over a portion of the child. The flap section extends from the main section. The flap section is secured with respect to the main section such that the flap section cooperates with the main section to restrain the child's torso, arms, and legs. The method further comprises inflating an inflatable chamber defined by the flexible shell.

### BRIEF DESCRIPTION OF THE DRAWINGS

It is believed that certain embodiments will be better understood from the following description taken in conjunction with the accompanying drawings in which:

FIG. 1 is a top perspective view depicting a child carrier in accordance with one embodiment, wherein the flap sections of the child carrier are in an opened position;

FIG. 2 is a bottom plan view depicting the child carrier of FIG. 1;

FIG. 3 is a schematic view depicting the inflatable chambers, passageways, zip cord, valve, and compression fluid reservoirs of the child carrier of FIG. 1;

FIG. 4 is a top perspective view depicting the child carrier of FIG. 1 in association with a young child, wherein a portion of the lower flap is folded over the young child, and wherein certain concealed portions of the young child are shown in dashed lines;

FIG. 5 is a top perspective view depicting the child carrier of FIG. 4, wherein a portion of a side flap is folded over the young child;

FIG. 6 is a perspective view depicting the child carrier of FIG. 1 in association with an adult and a young child, wherein the child carrier is used as a backpack to retain the young child and wherein the adult is grasping the zip cord to inflate the child carrier;

FIG. 7 is a perspective view depicting a child carrier in accordance with another embodiment, wherein a parachute is coupled with a flexible shell;

FIG. 8 is a perspective view depicting a child carrier in accordance with yet another embodiment, and in association with other items; and

FIG. 9 is a top perspective view depicting a child carrier in accordance with still another embodiment, wherein the flap sections of the child carrier are in an opened position.

### DETAILED DESCRIPTION

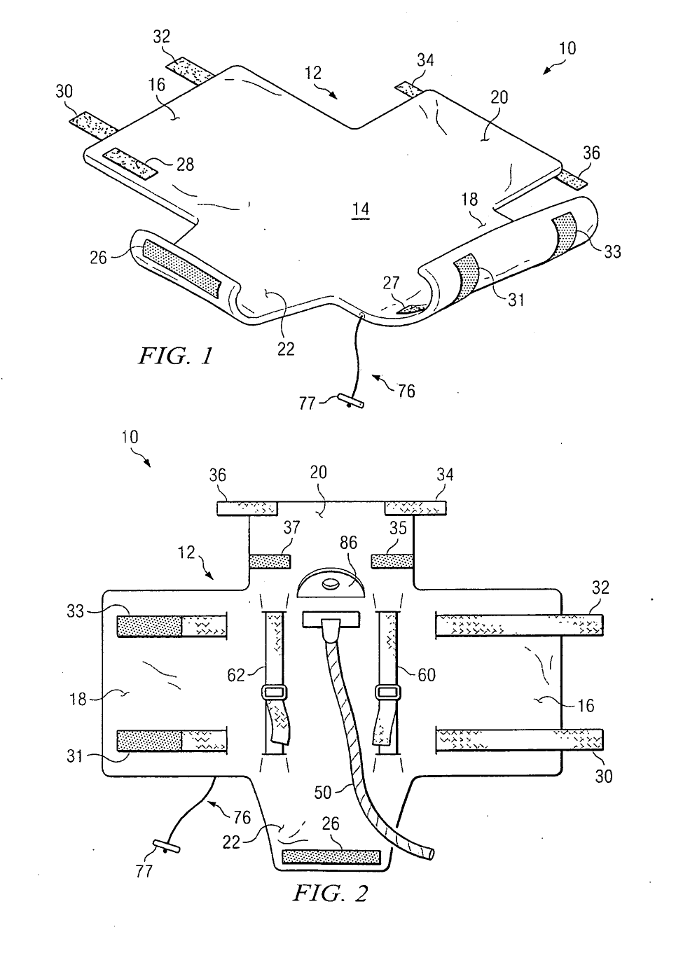

Embodiments are hereinafter described in detail in connection with the views and examples of FIGS. 1-9, wherein like numbers indicate the same or corresponding elements throughout the views. A child carrier 10 can be provided for protecting a young child 90. As illustrated in FIGS. 1-6, the child carrier 10 can comprise a flexible shell 12. The flexible shell 12 can be formed partially or entirely of a flexible material such as polypropylene, cloth, or rubber. However, any of a variety of other materials can additionally or alternatively be provided to form the flexible shell 12. It will be appreciated that the flexible shell 12 can be manufactured from one piece or any number of pieces of flexible material attached together by sewing, adhesive, rivets, and/or any of a variety of other suitable fastening methods or arrangements.

In accordance with one embodiment, with reference to FIG. 1, the flexible shell 12 can comprise a main section 14 and at least one flap section extending from the main section 14. In one embodiment, and with further reference to FIG. 1, the flap sections can include a left portion 16 and a right portion 18 extending from opposite sides of the main section 14. The flap sections can also include a lower section 22 extending from the main section 14. A hood section 20 can extend from the main section 14 opposite the lower section 22.

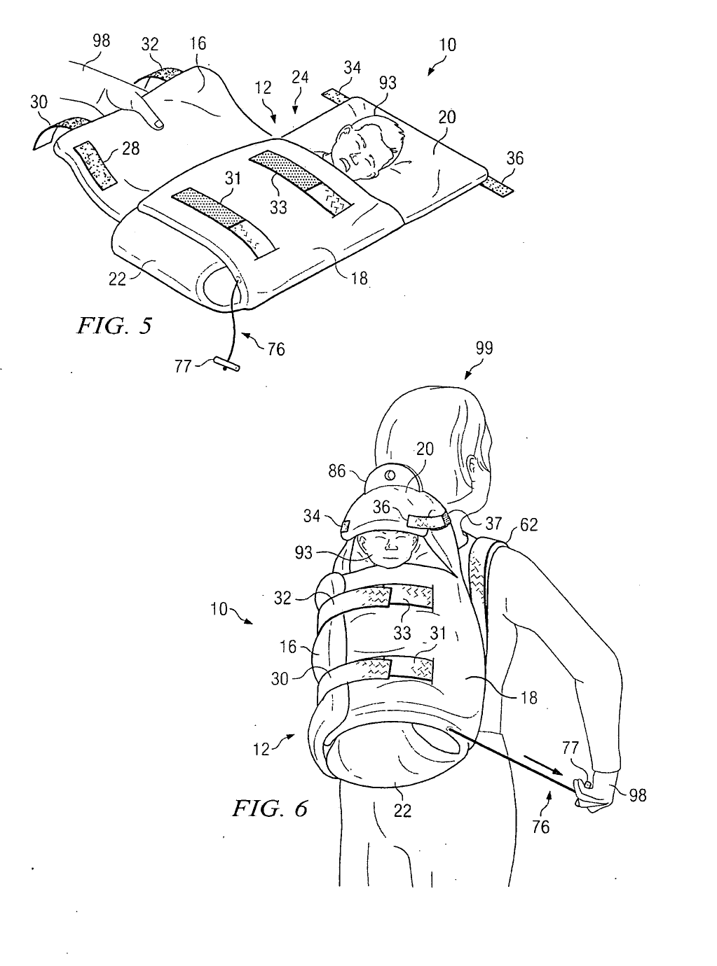

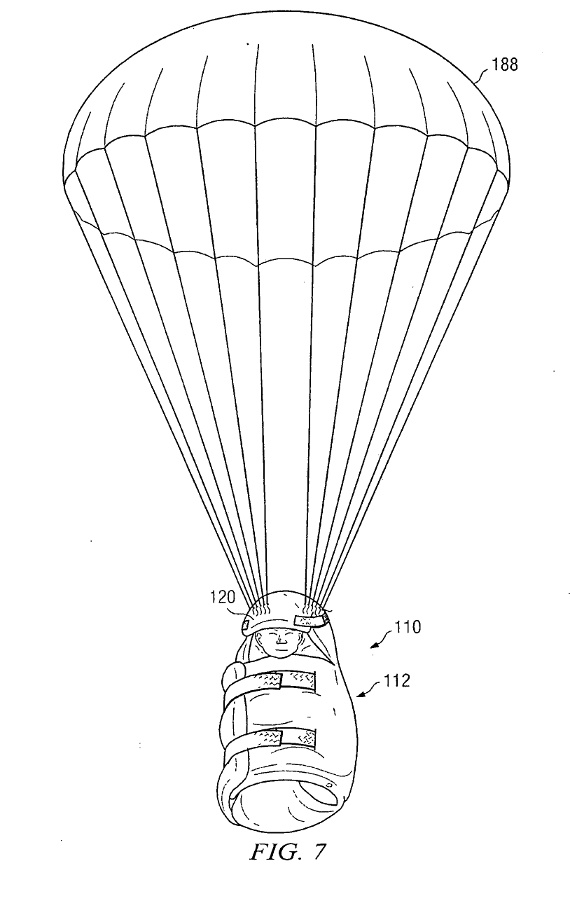

In accordance with one embodiment, as shown in FIG. 4, a young child 90 can be placed on the main section 14 of the flexible shell 12 when the child carrier 10 is in an opened position. Each flap section can be selectively foldable with respect to the main section 14. In one embodiment, the lower section 22 can be folded over the young child's legs 96 and 97 to cover at least a portion of the legs 96 and 97. The right portion 18 can then be folded over a torso 92 of the young child 90, as shown in FIG. 5. A hand 98 of an adult 99 can then fold the left portion 16 over the torso 92 and a portion of the right portion 18. As shown in FIG. 6, the left portion 16 and the right portion 18 are shown to partially overlap one another when in the wrapped position.

It will be appreciated that the order in which flap portions of a child carrier are folded over a young child can vary. For instance, in certain alternative embodiments, a lower section can be folded over the feet of a young child after one or both of the left and right portions are folded over the torso of the young child. In another alternative embodiment, an adult can fold a right portion over a torso of a young child after a left portion has been folded over the torso of the young child. However, in still another embodiment, left and right portions can be configured so as not to partially overlap one another when in the wrapped position. For instance, in one embodiment, respective edges of the left and right portions can be selectively attached together (e.g., by a zipper) at an interface. In still another embodiment, left and right portions might be formed as a unitary structure. In yet another embodiment, the lower section can be configured so as not to partially overlap one or both of the left and right portions when in the wrapped position.

When in the wrapped position, as shown in FIG. 6, the left portion 16, the right portion 18, and the lower section 22 can cooperate with the main section 14 to define a cavity (generally identified as 24 in FIG. 5) and restrain within the cavity 24 the torso 92, the arms 94 and 95, and the legs 96 and 97 of the young child 90. Furthermore, when in the wrapped position, it will be appreciated that the child carrier 10 can fit snugly around the young child 90 for securely encapsulating the young child 90. In one example, the young child 90 can be a child younger than four years of age. In another example, the young child can be a child younger than three years of age. In yet another example, the young child 90 can be a child younger than two years of age. In yet another example, the young child 90 can be a child younger than one year of age. In yet another example, the young child 90 can be a child younger than six months of age. In yet another example, the young child 90 can be an infant.

One or more fasteners can be associated with the flexible shell 12 for selectively restraining the child carrier 10 in a wrapped position. It will be appreciated that these fasteners can be provided in any of a variety of suitable locations and configurations, and can include snaps, buckles, hooks and loops, buttons, zippers, and/or any of a variety of other suitable devices. The fasteners can be attached to the flexible shell 12 through use of sewing, adhesive, rivets, and/or any of a variety of other suitable fastening methods or arrangements.

In one embodiment, a fastener can be provided for selectively retaining the lower section 22 to one or both of the left portion 16 and the right portion 18. In particular, such a fastener is shown in FIGS. 1-5 to include first and second mating portions 26, 27 which are respectively attached to the lower section 22 and the right portion 18. One of the first and second mating portions 26, 27 can comprise hooks of a hook/loop arrangement, while the other of the first and second mating portions 26, 27 can comprise loops of the hook/loop arrangement. Another mating portion 28 is shown to be attached to the left portion 16 and to comprise hooks or loops of a hook/loop arrangement for selectively engaging the hooks or loops of the mating portion 26.

Fasteners are also shown to be provided for selectively retaining the left portion 16 to the right portion 18. In particular, a first such fastener is shown in FIGS. 1-6 to include first and second mating portions 30, 31 respectively attached to the left portion 16 and the right portion 18. One of the first and second mating portions 30, 31 can comprise hooks of a hook/loop arrangement, while the other of the first and second mating portions 30, 31 can comprise loops of the hook/loop arrangement. A second such fastener is shown in FIGS. 1-6 to include first and second mating portions 32, 33 respectively attached to the left portion 16 and the right portion 18. One of the first and second mating portions 32, 33 can comprise hooks of a hook/loop arrangement, while the other of the first and second mating portions 32, 33 can comprise loops of the hook/loop arrangement.

The above-described fasteners can cooperate to facilitate secure restraint of the torso 92, arms 94 and 95, and legs 96, 97 of the young child 90 by the child carrier 10 when in the wrapped position, as shown in FIG. 6. One or more additional fasteners can be provided to facilitate protection of a head 93 of the young child 90 by the child carrier 10, such as when the hood section 20 is folded over a portion of the head 93 of the young child 90 as shown in FIG. 6. For example, a first such fastener is shown in FIGS. 1-6 to include first and second mating portions 34, 35 attached to the hood section 20. One of the first and second mating portions 34, 35 can comprise hooks of a hook/loop arrangement, while the other of the first and second mating portions 34, 35 can comprise loops of the hook/loop arrangement. A second such fastener is shown in FIGS. 1-6 to include first and second mating portions 36, 37 attached to the hood section 20. One of the first and second mating portions 36, 37 can comprise hooks of a hook/loop arrangement, while the other of the first and second mating portions 36, 37 can comprise loops of the hook/loop arrangement. It will be appreciated that any of a variety of suitable types, quantity, location, and configuration of fasteners can be provided upon a child carrier in accordance with alternative embodiments.

It will be appreciated that, when the child carrier 10 is in the wrapped position, the child carrier 10 can restrain and offer protection and coverage to substantially the entire body of the young child 90. Except for a portion of the young child's face; all extremities can be covered by the child carrier 10 while in the wrapped position. The fasteners can ensure that the young child 90 remains firmly secure within the child carrier 10 when in the wrapped position.

The child carrier 10 can also include a carrier strap. The carrier strap can be attached to the flexible shell 12 through use of any of a variety of suitable methods or arrangements. In one embodiment, as shown in FIG. 2, the carrier strap can include two shoulder straps 60 and 62 which are attached to the main section 14 of the flexible shell 12 (e.g., such as through use of sewing and/or adhesives). In one embodiment, as shown in FIG. 6, shoulder straps 60 and 62 can be configured to facilitate use of the child carrier 10 as a backpack so that the young child 90 can be conveniently carried by the adult 99. The shoulder straps 60 and 62 can be adjustable in length to facilitate comfortable use of the child carrier 10 as a backpack by adults (e.g., 99) of different sizes. Through use of the child carrier 10 as a backpack, as shown in FIG. 6, it will be appreciated that the adult 99 can carry a young child 90 out of an emergency situation, while still retaining full use of the adult's hands and arms to aid in the exit from the emergency situation. It will be appreciated that the shoulder straps 60 and 62 can also allow the child carrier 10 to be carried as a forward-facing pack which rests against the chest of the adult 99. It will also be appreciated that one or more carrier straps can be attached to a main section or another portion of a child carrier in any of a variety of other suitable configurations.

The child carrier 10 can also include a hoisting apparatus. The hoisting apparatus can be attached to the flexible shell 12 through use of any of a variety of suitable methods or arrangements. In one embodiment, the hoisting apparatus can comprise a rope 50 which extends from the main section 14. The rope 50 can be used by a rescuer of the young child 90 to facilitate carrying, raising, and/or lowering of the child carrier 10. In alternative embodiments, it will be appreciated that a hoisting apparatus might not comprise a rope, but can instead comprise a string, a leash, a cable, a harness, a nylon strap, and/or any of a variety of other suitable structures. In one embodiment, the rope 50 can be grasped by the hand of a rescuer (and/or by a winch of a rescue vehicle) to pull or lift the young child 90 and the child carrier 10 from a dangerous situation. For example, the rope 50 can facilitate lifting of the young child 90 and the child carrier 10 from a body of water. In another example, the rope 50 can facilitate carrying of the young child 90 and the child carrier 10 out of, and away from, a burning building.

A ring 86 can be attached to the main section 14, as shown in FIG. 2. The ring 86 can be attached to the flexible shell 12 through use of any of a variety of suitable methods or arrangements. The ring 86 can be configured to facilitate hanging of the child carrier 10, such as upon a wall hook, for example. It will be appreciated a hook, loop, or alternative hanging apparatus can additionally or alternatively be attached to the main section 14 to facilitate hanging of the child carrier 10. It will also be appreciated that provision of the ring 86 and/or some other hanging apparatus can facilitate convenient storage of the child carrier 10, and thus an increased likelihood that the child carrier 10 will be conveniently available for use in an emergency situation. In one embodiment, the ring 86 might be sized and of sufficient strength to facilitate its use as a location for receiving the hook of a hoist used to facilitate lifting of the young child 90 and the child carrier 10 such as during an emergency situation.

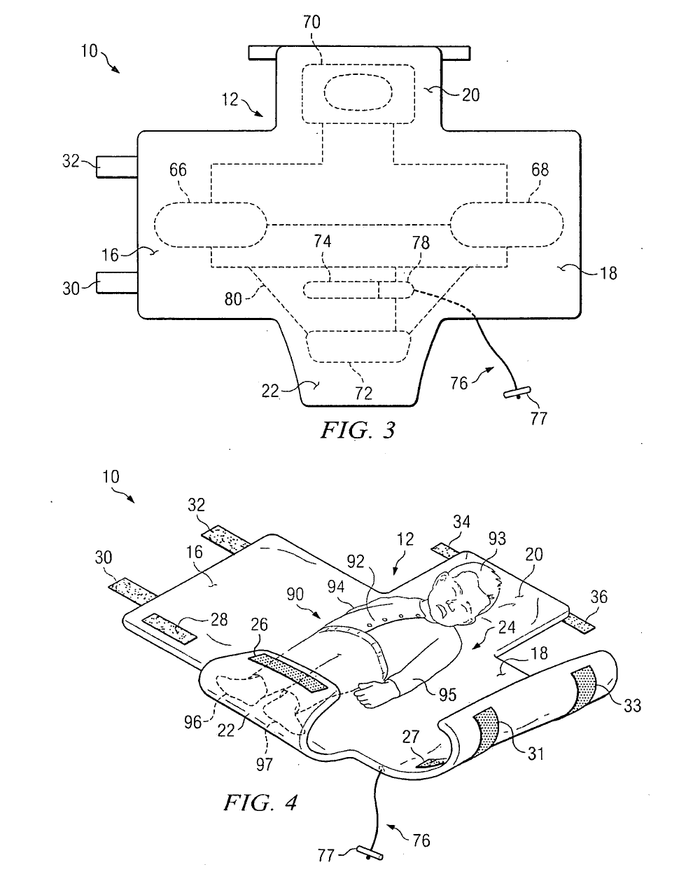

The child carrier 10 can comprise at least one inflatable chamber. In one embodiment, inflatable chambers can be defined by portions of the flexible shell 12 which are attached together (e.g., with sewing and/or adhesives) to form internal cavities. In another embodiment, inflatable chambers can be provided in the form of inflatable bags, balloons, or bladders which are sewn or otherwise secured within pockets formed in the flexible shell 12. In one embodiment, as shown schematically in FIG. 3, inflatable chambers 66, 68, 70, and 72 are shown to be provided in the main section 14, the hood section 20, and the flap sections, including the left portion 16, the right portion 18, and the lower section 22. It will be appreciated that inflatable chambers can be provided in any of a variety of other suitable sizes, arrangements, locations, and/or quantity.

A compression fluid reservoir 74 (e.g., a tank), as shown schematically in FIG. 3, can also be provided in the main section 14. The compression fluid reservoir 74 can be configured to store liquefied or pressurized gas such as ambient air and/or any of a variety of other gases such as, for example, carbon dioxide or nitrogen. The compression fluid reservoir 74 can be provided in selective fluid communication with the inflatable chambers 66, 68, 70, and 72 such as by way of a valve 78 and one or more conduit(s) (e.g., 80), as shown schematically in FIG. 3. Upon opening of the valve 78, as described below, pressurized gas can pass from the compression fluid reservoir 74, through the conduit(s) (e.g., 80), and into the inflatable chambers 66, 68, 70, and 72, thus dramatically increasing the buoyancy of the child carrier 10. The valve can close once the desired volume of pressurized gas has entered the inflatable chambers 66, 68, 70, and 72, and the pressurized gas can remain within the inflatable chambers until such time as it is released by an operator (e.g., by way of a release valve, not shown). The valve 78 can again be opened from time to time by an operator to allow additional pressurized gas to enter the inflatable chambers 66, 68, 70, 72.

In one embodiment, a zip cord 76 can be attached to the valve 78 to facilitate selective communication of gas from the compression fluid reservoir 74, through the conduit(s) (e.g., 80), and to the inflatable chambers 66, 68, 70, and 72. The zip cord 76 can include a handle 77 is which facilitates grasping and pulling of the zip cord 76 by an operator, and resultant inflation of the inflatable chambers 66, 68, 70, and 72 as described above. When the zip cord 76 is released, it will be appreciated that the valve 78 can close, thus blocking passage of additional pressurized gas to the inflatable chambers 66, 68, 70, and 72 until such time as the zip cord 76 is again pulled by an operator. One or more manual fill spouts (not shown) might additionally be provided to facilitate manual inflation of the inflatable chambers 66, 68, 70, and 72 by the mouth of an adult 99. Such manual fill spouts can be useful to facilitate filling of the inflatable chambers 66, 68, 70, and 72 even during such time as the pressurized gas within the compression fluid reservoir 74 is depleted. In one alternative embodiment, a child carrier having such manual fill spouts might not include a compression fluid reservoir (e.g., 74).

It will be appreciated that the inflatable chambers 66, 68, 70, and 72 can be strategically placed such that, when inflated, the child carrier 10 can float upright when supporting the young child 90 in a body of water, and such that the head 93 of the young child 90 is maintained above water by the child carrier 10. Also, when the inflatable chambers 66, 68, 70, and 72 are inflated, the child carrier 10 can also protect the young child 90 from bumps and bruises such as might otherwise be experienced during an exit from an emergency situation. Additionally, when the inflatable chambers 66, 68, 70, and 72 are inflated, the child carrier 10 can even help to protect the young child 90 from injuries that might otherwise be sustained by the young child 90 during a fall or drop if not protected by the child carrier 10.

The child carrier 10 can be used to protect a young child 90 in an emergency situation. For example, in order to use the child carrier 10, the adult 99 can first unfold the child carrier 10 to a position such as that shown in FIG. 1. The opened child carrier 10, as shown in FIG. 1, can be placed on a table, the ground, or other surface in order to facilitate the placing of the young child 90 onto the main section 14 of the flexible shell 12, as shown in FIG. 4. After the young child 90 is placed onto the main section 14 of the flexible shell 12, the adult 99 can fold the flap section(s) of the flexible shell 12 over a portion of the young child 90. For example, a lower section 22 extending from the main section 14 can be folded over the young child's legs 96 and 97, as shown in FIG. 4. The adult 99 can then use his or her hand 98 to fold the right portion 18 over the young child 90, as shown in FIG. 5, such that the lower section 22 is secured to the right portion 18 by way of mating portions 26, 27 as described above. The adult 99 can then fold the left portion 16 with his or her hand 98 over the right portion 18. The adult 99 can then secure the flap sections with respect to the main section 14 by overlapping and engaging the mating portions 30, 31 and 32, 33. Once secured, the flap sections can cooperate with the main section 14 to restrain the torso 92, arms 94 and 95, and legs 96 and 97 of the young child 90. It will be appreciated that, for additional protection, the adult 99 can fold the hood section 20 of the flexible shell 12 over a portion of the head 93 of the young child 90, and can then engage the mating portions 34, 35 and 36, 37, such as shown in FIG. 6.

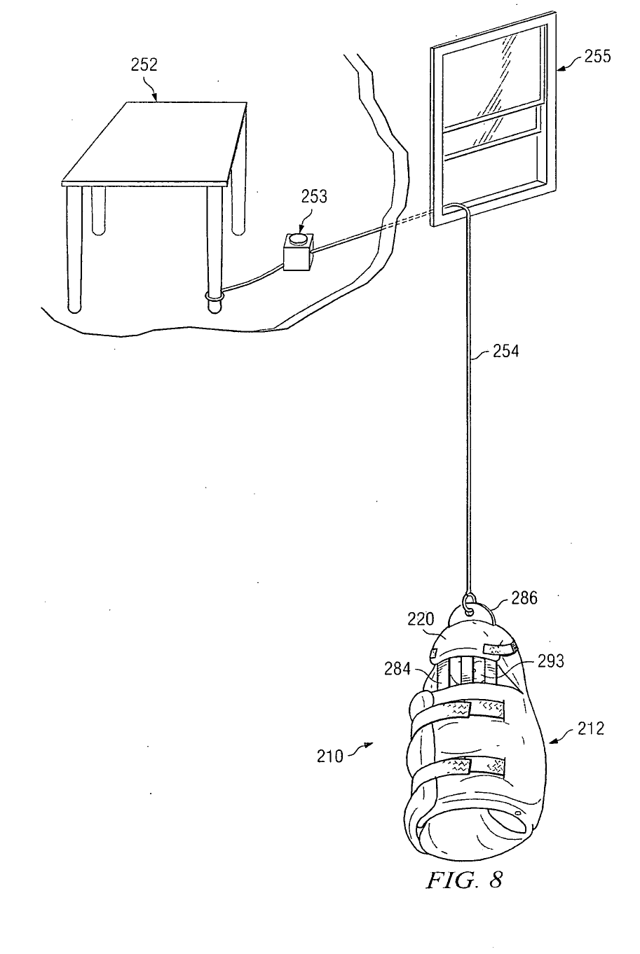

Once the young child 90 is fully secured in the child carrier 10, the adult 99 can carry the child carrier 10 such as through use of a carrier strap attached to the flexible shell 12. For example, as shown in FIG. 6, an adult 99 can carry the flexible shell 12 as a backpack through use of the shoulder straps 60 and 62. It will be appreciated that the carrying of the child carrier 10 as a backpack allows the adult 99 to maintain full use of his or her hands (e.g., to open doors) to aid in the escape of the adult 99 and young child 90 from an emergency situation. It will be appreciated that, if the young child 90 must be evacuated from an emergency situation in which the adult 99 cannot carry the young child 90, the rope 50 can be used to facilitate raising or lowering of the young child 90 and the child carrier 10. For instance, the young child 90 can be lowered from a window to a safe area below through use of the rope 50. In an alternative embodiment, as shown in FIG. 8 and described further below, a line 254 coupled to a ring 286 attached to a flexible shell 212 of a child carrier 210 can facilitate the lowering of a young child out of an emergency situation.

Once the young child 90 is secured in the child carrier 10, it will be appreciated that additional protection can be provided in an emergency situation by inflating one or more inflatable chambers in the child carrier 10. As shown in FIG. 6, an adult 99 can inflate the inflatable chambers by pulling the zip cord 76 by the handle 77 with his or her hand 98. When the inflatable chambers are inflated, the child carrier 10 can protect a young child 90 from bumps and bruises, short fall drops, as well as water emergencies.

The flexible shell 12 allows the child carrier 10 to be folded into a compact shape for easy transportation and storage. It will be appreciated that the child carrier 10 can provide easy, quick, and portable protection for young children in an emergency situation. Also the portability of the child carrier 10 provides for convenient and efficient storage, and a resultant strong likelihood that the child carrier 10 will be taken with an adult and resultantly available in an emergency situation.

A child carrier can be provided in any of a variety of alternative embodiments. One such alternative embodiment is depicted in FIG. 7. As shown in FIG. 7, a parachute 188 can be coupled to a flexible shell 112 of a child carrier 110. The parachute 188 can be coupled with the flexible shell 112 in a variety of suitable arrangements. In one embodiment, as shown in FIG. 7, the parachute 188 can be sewn or otherwise permanently attached to the flexible shell 112. In another embodiment, a parachute can be a separate device harnessed to a child carrier (e.g., attached to the ring 86 of the child carrier 10 of FIGS. 1-6, such as through use of a carabiner. The parachute 188 can be formed partially or entirely of woven nylon fabric, silk, or linen. However, any of a variety of other materials can additionally or alternatively be provided to form the parachute 188. It will be appreciated that, in an emergency situation, where a young child must be lowered to the ground, the parachute 188 can slow the descent of the child carrier 110 and young child, thus aiding in the young child's sale descent to the ground.

Referring again to FIG. 8, the flexible shell 212 of the child carrier 210 is shown to be suspended by the line 254 coupled to the ring 286. The line 254 is shown to extend through a window 255 of a structure, such as a house or a building, and to be secured to a leg of a table 252 within the house or building. In lieu of a table, the line 254 can instead be secured to a bed, a chair, a person, and/or any of a variety of other suitable structures within the house or building. It will be appreciated that the child carrier 210, in such an arrangement, be configured to facilitate a child's escape from a burning house or building. Alternatively, the child carrier 210 can be lowered not from a window, but rather from a roof, a balcony, a vehicle, or any of a variety of suitable locations. The line 254 is shown to be provided with a tension structure 253. The tension structure 253 can be configured to dispense the length of the line 254 in a controlled manner and can accordingly include a ratchet mechanism, a spool, a friction mechanism, or some other suitable arrangement which can be used by an adult operator to facilitate a controlled descent of the child carrier 210. With further reference to FIG. 8, the child carrier 210 is shown to comprise a face mask 284. The face mask 284 can be made from any of a variety of suitable materials for example, the face mask 284 can be formed partially or entirely of a flexible material such as polypropylene, cloth, or rubber. However, any of a variety of other materials can additionally or alternatively be provided to form the face mask 284. The face mask 284 can be provided in any of a variety of suitable arrangements and can be coupled to the flexible shell 212 by any of a variety of suitable releasable fastening methods, such as buttons, snaps, hooks and loops, or can alternatively be permanently attached, such as through use of sewing or adhesives. In one embodiment the face mask can be inflatable. It will be appreciated that the face mask can protect a young child's face from injury during an emergency situation.

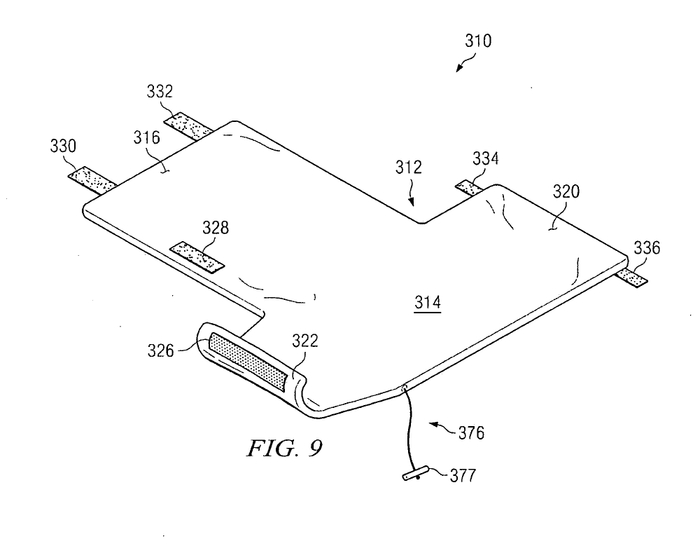

A child carrier 310 in accordance with another embodiment is depicted in FIG. 9. In particular, the child carrier 310 is shown to include a flexible shell 312 which comprises a main section 314 and flap sections 316 and 322 which can be selectively foldable with respect to the main section 314. The flap section 322 can be selectively folded over legs of a young child and can be secured by engaging mating portions 326 and 328 of a fastener. The flap section 316 can wrap about the torso of the young child and can be secured by engaging respective mating portions 330 and 332 with corresponding mating portions (not shown) of respective fasteners and such as can be attached to a rear surface (not shown) of the main section 314. A hood section 320 can extend from the main section 314 opposite the lower section 322 and can include fasteners including mating portions (e.g., 334, 336) such as for use in maintaining the hood section 320 in position when wrapped about a portion of the head of the young child. The child carrier is also shown to include a zip cord 376 having a handle 377 such as for selective use by an adult to facilitate inflation of inflatable chambers associated with the flexible shell. Much as described above with respect to the child carrier 10 of FIGS. 1-6, the child carrier 110 of FIG. 7, the child carrier 210 of FIG. 8, and the child carrier 310 of FIG. 9 can be used to restrain, cover, and protect a young child.

The foregoing description of embodiments and examples has been presented for purposes of illustration and description. It is not intended to be exhaustive or to limit the invention to the forms described. Numerous modifications are possible in light of the above teachings. Some of those modifications have been discussed and others will be understood by those skilled in the art. The embodiments were chosen and described in order to best illustrate certain principles and various embodiments as are suited to the particular use contemplated. The scope of the invention is, of course, not limited to the examples or embodiments set forth herein, but can be employed in any number of applications and equivalent devices by those of ordinary skill in the art. Rather it is hereby intended the scope of the invention be defined by the claims appended hereto.

What is claimed is:

1. A child carrier comprising:
a flexible shell comprising a main section and at least one flap section extending from the main section, said flap section being selectively foldable with respect to the main section from an opened position to a wrapped position, in which wrapped position said flap section is configured to cooperate with the main section to define a cavity and restrain a child's torso, arms, and legs within the cavity;
a fastener attached to the flexible shell and configured to selectively retain said flap section in the wrapped position; and
a carrier strap attached to the flexible shell.

2. The child carrier of claim 1 wherein said flap section comprises a left portion and a right portion extending from opposite sides of the main section and being configured to partially overlap one another when in the wrapped position.

3. The child carrier of claim 2 further comprising a hood section extending from the main section.

4. The child carrier of claim 3 wherein said flap section further comprises a lower section extending from the main section opposite the hood section.

5. The child carrier of claim 1 wherein the carrier strap comprises at least two shoulder straps configured to facilitate use of the child carrier as a backpack.

6. The child carrier of claim 1 wherein the fastener comprises a hook and loop fastener arrangement.

7. The child carrier of claim 1 further comprising a ring attached to the main section, the ring being configured to facilitate hanging of the child carrier.

8. The child carrier of claim 1 wherein at least one of the main section and said flap section defines an inflatable chamber.

9. The child carrier of claim 8 further comprising a compression fluid reservoir in selective fluid communication with the inflatable chamber.

10. A child carrier comprising:
a flexible shell comprising a main section and at least one flap section extending from the main section, said flap section being selectively foldable with respect to the main section from an opened position to a wrapped position, in which wrapped position said flap section is configured to cooperate with the main section to define a cavity and restrain a child's torso, arms, and legs within the cavity, wherein at least one of the main section and said flap section defines an inflatable chamber.

11. The child carrier of claim 10 further comprising a fastener attached to the flexible shell and configured to selectively retain said flap section in the wrapped position.

12. The child carrier of claim 10 further comprising a compression fluid reservoir in selective fluid communication with the inflatable chamber.

13. The child carrier of claim 12 further comprising a zip cord associated with the compression fluid reservoir and configured to facilitate selective fluid communication from the compression fluid reservoir to the inflatable chamber.

14. The child carrier of claim 10 further comprising at least two shoulder straps attached to the flexible shell and configured to facilitate use of the child carrier as a backpack.

15. The child carrier of claim 10 further comprising a hood section extending from the main section.

16. A child carrier comprising:
a flexible shell comprising a main section and at least one flap section extending from the main section, said flap section being selectively foldable with respect to the main section from an opened position to a wrapped position, in which wrapped position said flap section is configured to cooperate with the main section to define a cavity and restrain a child's torso, arms, and legs within the cavity;
a fastener attached to the flexible shell and configured to selectively retain said flap section in the wrapped position; and
a parachute coupled with the flexible shell.

17. A method for protecting a young child, the method comprising:
placing a child on a main section of a flexible shell;
folding a flap section of the flexible shell over a portion of the child, the flap section extending from the main section;
securing the flap section with respect to the main section such that the flap section cooperates with the main section to restrain the child's torso, arms, and legs; and
carrying the flexible shell through use of a carrier strap attached to the flexible shell.

18. The method of claim 17 wherein the carrying comprises carrying the flexible shell as a backpack, wherein the carrier strap comprises two shoulder straps.

19. The method of claim 17 further comprising inflating an inflatable chamber defined by the flexible shell.

20. The method of claim 19 further comprising pulling a zip cord to effect the inflating of the inflatable chamber.

21. The method of claim 17 further comprising donning a hood section of the flexible shell over a portion of the child's head, wherein the hood section extends from the main section.

22. The method of claim 17 further comprising lowering the flexible shell through use of a hoisting apparatus attached to the main section.

23. A method for protecting a young child, the method comprising:
placing a child on a main section of a flexible shell;
folding a flap section of the flexible shell over a portion of the child, the flap section extending from the main section;
securing the flap section with respect to the main section such that the flap section cooperates with the main section to restrain the child's torso, arms, and legs; and
inflating an inflatable chamber defined by the flexible shell.

24. The method of claim 23 further comprising pulling a zip cord to effect the inflating of the inflatable chamber.

25. The method of claim 23 further comprising donning a hood section of the flexible shell over a portion of the child's head, wherein the hood section extends from the main section.
